(19) United States
(12) Patent Application Publication
(10) Pub. No.: US 2026/0230385 A1
(43) Pub. Date: Aug. 6, 2026

(54) MULTIMODAL SERVICE DATA STREAM MANAGEMENT METHOD AND APPARATUS

(71) Applicant: BEIJING XIAOMI MOBILE SOFTWARE CO., LTD., Beijing (CN)

(72) Inventors: Jinhua WU, Beijing (CN); Yang SHEN, Beijing (CN)

(21) Appl. No.: 19/147,870

(22) PCT Filed: Jan. 16, 2023
(86) PCT No.: PCT/CN2023/072422

§ 371 Date: Jul. 14, 2025

(51) Int. Cl. H04L 41/0894; H04L 47/2483

(52) U.S. Cl. CPC H04L 41/0894; H04L 47/2483

(57) ABSTRACT

A method for managing a multimodal service data flow is performed by a policy control function (PCF). The PCF receives a request message sent by an application function (AF), and generates or updates a policy and charging control (PCC) rule according to the request message. The request message is configured to indicate at least one of: adding a service data flow into a first service data flow group; or removing a service data flow from a second service data flow group.

### CROSS-REFERENCE TO RELATED APPLICATION

This application is the US national phase application of International Application No. PCT/CN2023/072422, filed on Jan. 16, 2023, the entire contents of which are incorporated herein by reference for all purposes.

### TECHNICAL FIELD

The disclosure relates to the field of wireless communication technology, and in particular to a method and an apparatus for managing a multimodal service data flow.

### BACKGROUND

Mobile media services, XR (extended reality) services such as cloud AR (augmented reality)/VR (virtual reality), cloud gaming, and video based machine or drone remote control are expected to contribute increasingly high traffic to 5G wireless communication networks. XR services also involve multimodal data flows, which can be data input from the same device or different devices (including sensors) describing the same service or application. This data may be output to one or more destination terminals. The various data flows in multimodal data often have correlations, such as synchronization between audio and video flows, and synchronization between touch and vision.

### SUMMARY

In a first aspect, embodiments of the present disclosure provide a method for managing a multimodal service data flow. The method is performed by a PCF, and includes: receiving by the PCF, a request message sent by an application function (AF), and generating or updating a policy and charging control (PCC) rule according to the request message.

In a second aspect, embodiments of the present disclosure provide a method for managing a multimodal service data flow. The method is performed by an AF, and includes: sending a request message to a policy control function (PCF), wherein the request message is configured to indicate adding a service data flow to a first service data flow group and/or removing a service data flow from a second service data flow group.

In a third aspect, embodiments of the present disclosure provide a communication device. The communication device has the functionality to implement part or all of the PCF in the method described in the first aspect. For example, the communication device may have the functionality to implement part or all of the functions in the embodiments of the present disclosure, or may have the functionality to implement any of the embodiments separately. The functions can be implemented through hardware or by executing corresponding software through hardware. The hardware or software includes one or more units or modules corresponding to the above functions.

The communication device includes: a transceiver module, configured to receive a request message sent by an AF; and a processing module, configured to generate or update a PCC rule according to the request message.

In a fourth aspect, embodiments of the present disclosure provide another communication device. The communication device has the functionality to implement part or all of the AF in the method described in the second aspect. For example, the communication device may have the functionality to implement part or all of the functions in the embodiments of the present disclosure, or may have the functionality to implement any of the embodiments separately. The functions can be implemented through hardware or by executing corresponding software through hardware. The hardware or software includes one or more units or modules corresponding to the above functions.

The communication device includes: a transceiver module, configured to send a request message to a PCF, wherein request message is configured to indicate adding a service data flow to a first service data flow group and/or removing a service data flow from a second service data flow group.

In a fifth aspect, embodiments of the present disclosure provide a communication device. The communication device includes a processor which, when calling a computer program stored in a memory, implements the method described in the first aspect.

In a sixth aspect, embodiments of the present disclosure provide a communication device. The communication device includes a processor which, when calling a computer program stored in a memory, implements the method described in the second aspect.

In a seventh aspect, embodiments of the present disclosure provide a communication device. The communication device includes a memory and a processor. The memory stores a computer program. The processor is configured to execute the computer program stored in the memory, to cause the communication device to implement the method described in the first aspect.

In an eighth aspect, embodiments of the present disclosure provide a communication device. The communication device includes a memory and a processor. The memory stores a computer program. The processor is configured to execute the computer program stored in the memory, to cause the communication device to implement the method described in the second aspect.

In a ninth aspect, embodiments of the present disclosure provide a communication device. The communication device includes a processor and an interface circuit. The interface circuit is configured to receive code instructions and transmit the code instructions to the processor. The processor is configured to run the code instructions, to cause the device to implement the method described in the first aspect.

In a tenth aspect, embodiments of the present disclosure provide a communication device. The communication device includes a processor and an interface circuit. The interface circuit is configured to receive code instructions and transmit the code instructions to the processor. The processor is configured to run the code instructions, to cause the device to implement the method described in the second aspect.

In an eleventh aspect, embodiments of the present disclosure provide a communication system. The system includes a communication device as described in the third aspect and a communication device as described in the fourth aspect, or the system includes a communication device as described in the fifth aspect and a communication device as described in the sixth aspect, or the system includes a communication device as described in the seventh aspect and a communication device as described in the eighth aspect, or the system includes a communication device as described in the ninth aspect and a communication device as described in the tenth aspect.

In a twelfth aspect, embodiments of the present disclosure provide a computer readable storage medium, configured to store instructions used by the PCF above, to cause the PCF to implement the method described in the first aspect, when executed.

In a thirteenth aspect, embodiments of the present disclosure provide a computer readable storage medium, configured to store instructions used by the AF above, to cause the AF to implement the method described in the second aspect, when executed.

In a fourteenth aspect, the present disclosure further provides a computer program product including a computer program which, when running on a computer, causes the computer to implement the method described in the first aspect.

In a fifteenth aspect, the present disclosure further provides a computer program product including a computer program which, when running on a computer, causes the computer to implement the method described in the second aspect.

In a sixteenth aspect, the present disclosure provides a chip system. The chip system includes at least one processor and an interface, for supporting the PCF to implement the functions involved in the first aspect, such as determining or processing at least one of the data and information involved in the above methods. In a possible design, the chip system further includes a memory for storing necessary computer programs and data for the PCF. This chip system can be composed of chips or include chips and other discrete components.

In a seventeenth aspect, the present disclosure provides a chip system. The chip system includes at least one processor and an interface, for supporting the AF to implement the functions involved in the second aspect, such as determining or processing at least one of the data and information involved in the above methods. In a possible design, the chip system further includes a memory for storing necessary computer programs and data for the AF. This chip system can be composed of chips or include chips and other discrete components.

In an eighteenth aspect, the present disclosure provides a computer program, which when running on a computer, causes the computer to implement the method described in the first aspect.

In a nineteenth aspect, the present disclosure provides a computer program, which when running on a computer, causes the computer to implement the method described in the second aspect.

### BRIEF DESCRIPTION OF THE DRAWINGS

In order to provide a clearer explanation of the technical solution in embodiments of the present disclosure or background technology, the accompanying drawings required for use in the embodiments of the present disclosure or background technology will be described below.

FIG. 1 is a schematic diagram of a communication network architecture provided in an embodiment of the present disclosure.

FIG. 2 is a schematic diagram of another communication network architecture provided in an embodiment of the present disclosure.

FIG. 3 is a schematic flowchart of a method performed by a policy control function (PCF) for managing a multimodal service data flow provided in an embodiment of the present disclosure.

FIG. 4 is a schematic flowchart of another method for managing a multimodal service data flow provided in an embodiment of the present disclosure.

FIG. 5 is a schematic flowchart of yet another method for managing a multimodal service data flow provided in an embodiment of the present disclosure.

FIG. 6 is a schematic flowchart of yet another method for managing a multimodal service data flow provided in an embodiment of the present disclosure.

FIG. 7 is a schematic flowchart of a method performed by an application function (AF) for managing a multimodal service data flow provided in an embodiment of the present disclosure.

FIG. 8 is a schematic flowchart of yet another method for managing a multimodal service data flow provided in an embodiment of the present disclosure.

FIG. 9 is a schematic flowchart of yet another method for managing a multimodal service data flow provided in an embodiment of the present disclosure.

FIG. 10 is a schematic flowchart of yet another method for managing a multimodal service data flow provided in an embodiment of the present disclosure.

FIG. 11 is a block diagram of a communication device provided in an embodiment of the present disclosure.

FIG. 12 is a block diagram of another communication device provided in an embodiment of the present disclosure.

FIG. 13 is a block diagram of a chip provided in an embodiment of the present disclosure.

### DETAILED DESCRIPTION

In order to better understand the method and apparatus for managing a multimodal service data flow disclosed in embodiments of the present disclosure, the following first describes the communication system applicable to embodiments of the present disclosure.

Reference will now be made in detail to the exemplary embodiments, examples of which are illustrated in the accompanying figures. When the following description refers to the accompanying figures, the same numerals in different figures refer to the same or similar elements, unless otherwise indicated. The implementations described in the following exemplary embodiments do not represent all implementations consistent with the embodiments of the disclosure. Rather, they are merely examples of devices and methods consistent with some aspects of the disclosure as recited in the appended claims.

The terms used in this disclosure are for the purpose of describing specific embodiments only and are not intended to limit this disclosure. The singular forms of “a”, “said”, and “this” used in this disclosure and the appended claims are also intended to include the majority form, unless the context clearly indicates otherwise. It should also be understood that the term “and/or” used in this article refers to and includes any or all possible combinations of one or more associated listed items.

It should be understood that although the terms first, second, third, etc. may be used in this disclosure to describe various information, these information should not be limited to them. These terms are only used to distinguish information of the same type from each other. For example, without departing from the scope of this disclosure, the first information may also be referred to as the second information, and similarly, the second information may also be referred to as the first information. Depending on the context, for example, the word ‘if’ used here can be interpreted as ‘when’ or ‘in a case’ or ‘in response to determining’.

It should be noted that the information (including but not limited to user equipment information, user personal information, etc.), data (including but not limited to data used for analysis, stored data, displayed data, etc.), and signals involved in this disclosure are all authorized by the user or fully authorized by all parties, and the collection, use, and processing of relevant data must comply with relevant laws, regulations, and standards of relevant countries and regions.

It should be understood that the technical solutions of various embodiments disclosed herein can be applied to various communication systems according to access standards, such as Global System of Mobile Communication (GSM), Code Division Multiple Access (CDMA) systems, Wideband Code Division Multiple Access Wireless (WCDMA), General Packet Radio Service (GPRS), Long Term Evolution (LTE), LTE Frequency Division Duplex (FDD) systems, LTE Time Division Duplex (TDD), Universal Mobile Telecommunication System (UMTS), wireless cellular network systems, 5G systems and future communication systems.

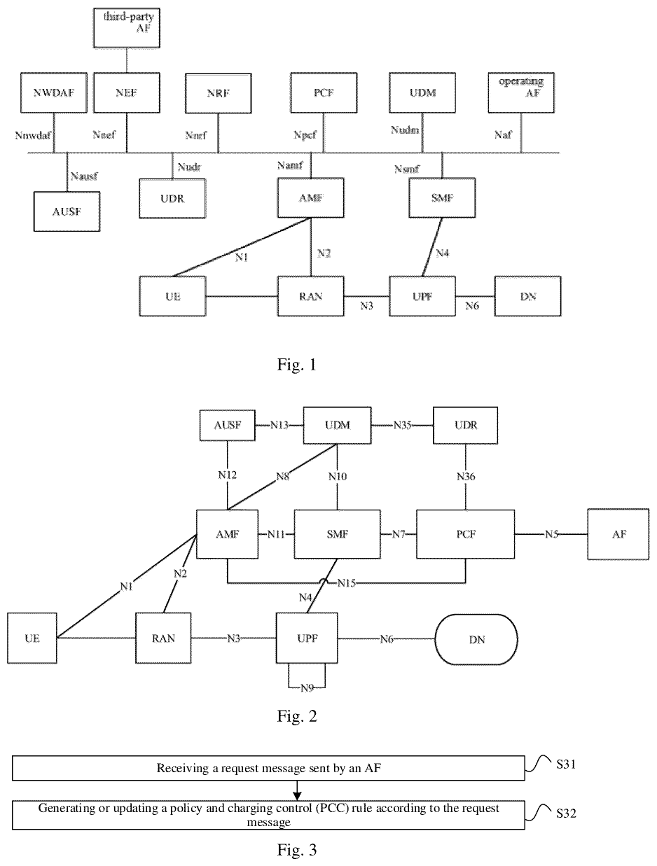

Referring to FIG. 1 and FIG. 2, they are schematic diagrams of two possible communication network architectures in the embodiments of the present disclosure. The communication network architecture can include three parts, namely the terminal part, the data network (DN) part, and the operator network part.

UE (user equipment) is an entity on the user side used for receiving or transmitting signals, such as a mobile phone. The terminal can also be referred to as terminal device, user equipment, mobile station (MS), mobile terminal (MT), etc. Terminals can be communication enabled cars, smart cars, mobile phones, wearable devices, tablets, computers with wireless transmission and reception capabilities, virtual reality (VR) terminal devices, augmented reality (AR) terminals, wireless terminals in industrial control, wireless terminals in autonomous driving, wireless terminals in remote medical surgery, wireless terminals in smart grids, wireless terminals in transportation safety, wireless terminals in smart cities, and wireless terminals in smart homes, etc. The specific technology and device form adopted by the terminal is not limited in embodiments of the present disclosure.

(Radio) Access Network ((R) AN) is used to provide network access functions for authorized terminals in specific areas, and can use transmission tunnels of different qualities according to the levels of terminals, service requirements, etc. (R)AN can manage wireless resources, provide access services for terminals, and thereby complete the forwarding of control information and/or data information between terminals and the core network (CN). The access network device in embodiments of the present disclosure is a device that provides wireless communication functionality for terminals, also known as a network device. The access network device may include: next generation node base station (gNB) in 5G system, evolved node B (eNB) in long-term evolution (LTE), radio network controller (RNC), node B (NB), base station controller (BSC), base transceiver station (BTS), home base station (e.g. home evolved node B or home node B, HNB), base band unit (BBU), transmitting and receiving point (TRP), transmitting point (TP), Pico, mobile switching center, or network device in future networks. It can be understood that the specific types of access network devices are not limited in embodiments of the present disclosure. The names of devices with access network functionality may vary in systems with different wireless access technologies.

The following is a brief introduction and explanation of some of the network functions.

The operator network may include one or more of the following network functions: authentication server function (AUSF), network exposure function (NEF), policy control function (PCF), unified data management (UDM), unified data repository (UDR), network repository function (NRF), application function (AF), access and mobility management function (AMF), session management function (SMF), RAN, and user plane function (UPF), Unified Data Repository (UDR), network data analytics function (NWDAF), etc. In the above-mentioned operator network, the part other than the wireless access network part can also be referred to as the core network part.

The following is a brief introduction of various functions.

AMF is responsible for user mobility management, including mobile status management, assigning temporary identifiers to users, authenticating and authorizing users.

The SMF is responsible for UPF selection, UPF reselection, Internet Protocol (IP) address allocation, establishment, modification, and release of bearers, and QoS control.

The PCF includes policy control decision-making and flow based charging control functions, including user subscription data management, policy control, charging policy control, QoS control, and more.

The UDM is responsible for managing subscription data and notifying the corresponding network functions when subscription data is modified.

The UDR is responsible for storing and retrieving subscription data, policy data, and public architecture data, etc; providing relevant data for UDM, PCF, and NEF. UDR should have different data access authentication mechanisms for different types of data, such as subscription data and policy data, to ensure the security of data access; UDR should be able to return a failure response carrying an appropriate reason value for illegal service-oriented operations or data access requests.

The AF is used to provide certain application layer services to UE, and AF has requirements for QoS policies and charging policies when providing services to UE, and needs to notify the network. Moreover, AF also requires application related information feedback from other network functions of the core network.

The NEF mainly supports the network capability exposure functions, exposing network capabilities and services to the outside world. The network function (NF) of the 3rd Generation Partnership Project (3GPP) releases functions and events to other NFs through the NEF. NF's exposed capabilities and events can be securely exposed to third-party applications. NEF uses UDR's standardized interface (Nudr) to store/retrieve structured data, and translate the exchange information of AF with the exchange information of internal network functions. For example, a conversion will be made between AF Service Identifier and internal 5G core information. Internal 5G core information may be, for example, data network name (DNN) or single network slice selection assistance information (S-NSSAI).

The UPF supports all or part of the following functions: interconnecting protocol data unit (PDU) sessions with data networks; group routing and forwarding function, such as supporting uplink classifiers for traffic to be forwarded to the data network, and supporting branching point function to support multi-homed PDU sessions; and packet detection function.

The AUSF is responsible for authentication function and executing network slice specific authentication and authorization (NSSAA) process.

The NWDAF is used for signaling interaction with other core networks to understand the status of the network. The core network can subscribe to NWDAF to understand the status of the network.

The UE radio capability management function (UCMF) is used to store dictionary entries corresponding to UE radio capability IDs assigned by public land mobile networks (PLMNs) or manufacturers. AMF can subscribe to UCMF to obtain new values for UE radio capability IDs assigned by UCMF, in order to cache them locally.

The OAM can cover the network functions of the access network and core network, and can collect data from these network functions of the access network and core network.

It should be noted that in FIG. 1, the third party (3rd) AF and operator AF belong to AF. The difference is that 3rd AF (such as WeChat service server and Alipay payment service server) is not controlled by the operator, and operator AF (such as proxy-call session control function (P-CSCF) in IP multimedia system) is controlled by the operator. When 3rd AF interacts with NWDAF, NEF is required.

FIG. 1 shows a schematic diagram of a communication network architecture based on a service-oriented architecture. In FIG. 1, any two network functions in NEF, NRF, PCF, UDM, AUSF, UDR, AMF, and SMF can use a service-oriented communication method. For example, the interfaces Nnef and Nausf used for communication between NEF and AUSF are both service-oriented interfaces. Similarly, interfaces Nnrf, Npcf, Nudm, Naf, Nudr, Namf, and Nsmf are all service-oriented interfaces. In addition, AMF can communicate with the terminal through the N1 interface, AMF can communicate with (R)AN through the N2 interface, RAN and UPF can communicate through the N3 interface, SMF and UPF can communicate through the N4 interface, the terminal can communicate with RAN through the air interface, and UPF and DN can communicate through the N6 interface.

FIG. 2 is a schematic diagram of a communication network architecture based on point-to-point interfaces. The main difference between FIG. 1 and FIG. 2 is that the interfaces between the various network functions in FIG. 2 are point-to-point interfaces, rather than service-oriented interfaces. For the clarity, UDSF, NEF, NWDAF, and NRF are not described. It should be noted that the core network in FIG. 2 can interact with UDSF, NEF, NWDAF, and NRF as needed. For clarity, OAM is not shown in FIG. 1 and FIG. 2. OAM can collect data from the access network and core network.

It can be understood that the terms introduced above may have different names in different fields or standards, so the names shown above should not be understood as limiting the embodiments of the present disclosure. The above network functions or functionalities can be network elements in hardware devices, software functions running on dedicated hardware, or virtualization functions instantiated on platforms (such as cloud platforms).

It should be noted that the functions involved in the embodiments of the present disclosure can also be referred to as network elements, functional devices or entities or functional entities. For example, access and mobility management can also be referred to as access and mobility management network element, access and mobility management functional device or access and mobility management entity or access and mobility management functional entity. The names of various functional devices are not limited in this disclosure, and those skilled in the art may replace the names of the above-mentioned functional devices with other names to perform the same functions, all of which are within the scope of protection of this disclosure. The above-mentioned functional devices can be network elements in hardware devices, software functions running on dedicated hardware, or virtualization functions instantiated on platforms (such as cloud platforms).

It can be understood that the communication system and network architecture described in this disclosure are intended to provide a clearer explanation of the technical solution of this disclosure, and do not constitute a limitation on the technical solution provided in this disclosure. Those skilled in the art will know that with the evolution of system architecture and the emergence of new business scenarios, the technical solution provided in this disclosure is also applicable to similar technical problems.

In addition, for the convenience of understanding the embodiments of the present disclosure, the following explanations are made.

First, in embodiments of the present disclosure, “indicate” may include both direct indication and indirect indication. When describing a certain information indicating A, it may include the information directly indicating A or indirectly indicating A, but it does not necessarily mean that A is carried in the information.

If the information indicated by the information is referred to as the information to be indicated, there are many ways to indicate the information to be indicated in the specific implementations, such as but not limited to directly indicating the information to be indicated, such as the information to be indicated itself or the index of the information to be indicated. It is also possible to indirectly indicate the information to be indicated by indicating other information, where there is a correlation between the other information and the information to be indicated. It is also possible to indicate only a part of the information to be indicated, while the other parts of the information to be indicated are known or pre-agreed upon. For example, it is also possible to use the pre-agreed arrangement order of various information (for example, specified in the protocol) to achieve the indication of specific information, thereby reducing the indication overhead to a certain extent.

The information to be indicated can be sent together as a whole or divided into multiple sub information for separate transmission, and the transmission period and/or timing of these sub information can be the same or different. The specific sending method is not limited in this disclosure. The transmission period and/or timing of these sub information can be pre-defined, such as according to the protocol.

Second, embodiments of the present disclosure list multiple implementations to clearly illustrate the technical solution of the embodiments of the present disclosure. Of course, those skilled in the art can understand that the multiple embodiments provided in this disclosure can be executed separately, combined with the methods of other embodiments in this disclosure, or executed separately or in combination with some methods in other related technologies, which is not limited in embodiments of the present disclosure.

The following provides a detailed introduction to the method and apparatus for managing a multimodal service data flow provided in this disclosure, in conjunction with the accompanying drawings.

Mobile media services, XR (extended reality) services such as cloud AR (augmented reality)/VR (virtual reality), cloud gaming, and video based machine or drone remote control are expected to contribute increasingly high traffic to 5G networks. XR services also involve multimodal data flows, which can be data input from the same device or different devices (including sensors) describing the same service or application. These data may be output to one or more destination terminals. The various data flows in multimodal data often have correlations, such as synchronization between audio and video flows, and synchronization between touch and vision. The data flows of this type of media services themselves, between various data flows, and the network transmission requirements of these service data flows all have some common characteristics. The effective identification and utilization of these characteristics will be more helpful for the transmission and control of networks and services, as well as for service security and user experience.

XRM (XR and media) services require the 5th generation system (5GS) to comprehensively consider the relevant data flow quality of service (QOS) characteristics of the service, such as the delay critical guaranteed bit rate (GBR), guaranteed flow bit rate (GFBR), packet delay budget (PDB), maximum data burst volume (MDBV) for breach, and whether these parameters can be simultaneously met and coordinated, involving the consistency guarantee of QoS authorization and execution for multiple XRM data flows of one UE and XRM data flows of multiple UEs.

However, in the 5GS system, there is currently no well-established mechanism to support the requirements of XRM services and multimodal services among multiple UEs, and there is no corresponding technical solution to support the consistency of policy decisions between multiple XRM data flows of one UE or between XRM data flows of multiple UEs.

Based on this, in embodiments of the present disclosure, the PCF receives the request message sent by the AF, wherein the request message is configured to indicate adding a service data flow into a first service data flow group and/or removing the service data flow from a second service data flow group; and generates or updates the PCC rule based on the request message. Thus, the PCF can determine the service data flow group to which the service data flow belongs, and generate or update the corresponding PCC rule, which can make more reasonable policy decisions and resource authorizations for the service data flow, ensuring consistency in policy decisions for service data flows belonging to the same service data flow group.

Please refer to FIG. 3, which is a flowchart of a method for managing a multimodal service data flow provided in an embodiment of the present disclosure. The method is performed by a PCF. As shown in FIG. 3, the method may include but is not limited to the following steps.

S31, receiving a request message sent by an AF.

In embodiments of the present disclosure, the PCF can receive the request message sent by the AF.

The request message is configured to indicate at least one of:
adding a service data flow to a first service data flow group; or
removing a service data flow from a second service data flow group.

In an embodiment of the present disclosure, the PCF can receive the request message sent by the AF, wherein the request message is configured to indicate adding the service data flow into the first service data flow group. Thus, the PCF can determine that the service data flow belongs to the first service data flow group.

In an embodiment of the present disclosure, the PCF can receive the request message sent by the AF, wherein the request message is configured to indicate removing the service data flow from the second service data flow group. Thus, the PCF can determine that the service data flow does not belong to the second service data flow group.

In an embodiment of the present disclosure, the PCF can receive the request message sent by the AF, wherein the request message is configured to indicate adding the service data flow into the first service data flow group and removing the service data flow from the second service data flow group. Thus, the PCF can determine that the service data flow belongs to the first service data flow group and does not belong to the second service data flow group.

It can be understood that the PCF receives the request message sent by the AF, which may indicate adding one or more service data flows to the first service data flow group. Thus, the PCF can determine the first service data flow group to which one or more service data flows belong.

It can be understood that the PCF receives the request message sent by the AF, which may indicate removing one or more service data flows from the second service data flow group. Thus, the PCF can determine the second service data flow group to which one or more service data flows do not belong.

It can be understood that the PCF receives the request message sent by the AF, which can indicate adding one or more service data flows to the first service data flow group and removing the one or more service data flows from the second service data flow group. Thus, the PCF can determine the first service data flow group to which the one or more service data flows belong and the second service data flow group to which they do not belong.

In some embodiments, the request message includes a group identifier corresponding to the service data flow, and the group identifier is associated with the first service data flow group or the second service data flow group.

In an embodiment of the present disclosure, the PCF receives the request message sent by the AF, and the request message includes the group identifier corresponding to the service data flow.

The group identifier may be a common identifier (common ID), or may be an XRM service identifier (XRM service ID). The common ID or XRM service ID can indicate different groups through different values, which is not specifically limited in embodiments of the present disclosure.

In an embodiment of the present disclosure, the group identifier may be associated with the first service data flow group, or the group identifier may also be associated with the second service data flow group.

It can be understood that the request message is used to indicate adding the service data flow to the first service data flow group and/or removing the service data flow from the second service data flow group.

In the request message, the group identifier corresponding to the service data flow is included. When the group identifier is associated with the first service data flow group, the request message can be used to indicate adding the service data flow to the first service data flow group and/or removing the service data flow from the second service data flow group.

In a case where the request message includes the group identifier corresponding to the service data flow, and the group identifier is associated with the second service data flow group, the request message can be used to indicate adding the service data flow to the first service data flow group and/or removing the service data flow from the second service data flow group.

In a possible implementation, the PCF may receive the request message sent by the AF, which includes the group identifier associated with the first service data flow group. The request message may be used to indicate adding the service data flow to the first service data flow group.

In another possible implementation, the PCF may receive the request message sent by the AF, which includes the group identifier associated with the first service data flow group. If the service data flow does not belong to any service data flow group before receiving the request message sent by the AF, the request message can be used to indicate adding the service data flow to the first service data flow group.

In another possible implementation, the PCF may receive the request message sent by the AF, which includes the group identifier associated with the second service data flow group. The request message can be used to indicate removing the service data flow from the second service data flow group.

In another possible implementation, the PCF may receive the request message sent by the AF, which includes the group identifier associated with the first service data flow group. If the service data flow is located in the second service data flow group before receiving the request message sent by the AF, the request message can be used to indicate adding the service data flow to the first service data flow group and removing the service data flow from the second service data flow group.

In some embodiments, before receiving the request message sent by the AF, the service data flow is located in the second service data flow group, or the service data flow does not belong to any service data flow group.

In an embodiment of the present disclosure, if the service data flow is located in the second service data flow group before the PCF receives the request message sent by the AF, then in a case where the PCF receives the request message sent by the AF, the request message includes the group identifier corresponding to the service data flow, and the group identifier is associated with the first service data flow group, the request message may indicate removing the service data flow from the second service data flow group. In addition, the request message may also indicate adding the service data flow into the first service data flow group.

In an embodiment of the present disclosure, if the service data flow does not belong to any service data flow group before the PCF receives the request message sent by the AF, then in a case where the PCF receives the request message sent by the AF, the request message includes the group identifier corresponding to the service data flow, and the group identifier is associated with the first service data flow group, the request message may indicate adding the service data flow into the first service data flow group.

In some embodiments, the request message includes an action indication corresponding to the service data flow.

In an embodiment of the present disclosure, the request message includes the action indication corresponding to the service data flow.

In an embodiment of the present disclosure, the PCF receives the request message sent by the AF, the request message includes the group identifier, the group identifier is associated with the first service data flow group or the second service data flow group, and the request message further includes the action indication corresponding to the service data flow.

The action indication may indicate at least one of:
adding the service data flow into the first service data flow group; or
removing the service data flow from the second service data flow group.

In a possible implementation, in a case that the PCF receives the request message sent by the AF, the request message includes the group identifier associated with the first service data flow group, and the request message further includes the action indication corresponding to the service data flow, the action indication can be used to indicate adding the service data flow to the first service data flow group.

It can be understood that in case that the PCF receives the request message sent by the AF, the request message includes the group identifier corresponding to the service data flow, the group identifier is associated with the first service data flow group, the request message further includes the action indication corresponding to the service data flow, and the action indication indicates adding the service data flow into the first service data flow group, then no matter whether the service data flow is previously in the service data flow group or in which service data flow group, the PCF can determine to add the service data flow to the first service data flow group based on the action indication in the request message.

If the service data flow is previously located in the first service data flow group, the PCF may not update group information of the service data flow, and may determine that the service data flow belongs to the first service data flow group.

In another possible implementation, in a case that the PCF receives the request message sent by the AF, the request message includes the group identifier associated with the second service data flow group, and the request message further includes the action indication corresponding to the service data flow, the action indication can be used to indicate removing the service data flow from the second service data flow group.

If the service data flow is previously located in the second service data flow group, the PCF may update group information of the service data flow based on the action indication in the request message, and may determine that the service data flow does not belong to the second service data flow group.

If the service data flow is previously located in a group other than the second service data flow group, the PCF may not update group information of the service data flow, and may determine that the service data flow does not belong to the second service data flow group.

In yet another possible implementation, in a case that the PCF receives the request message sent by the AF, the request message includes the group identifier associated with the first service data flow group, and the request message also includes the action indication corresponding to the service data flow, then if the service data flow belongs to the second service data flow group before the PCF receives the request message sent by the AF, the action indication can be used to indicate removing the service data flow from the second service data flow group, and in addition, the action indication can also be used to indicate adding the service data flow into the first service data flow group.

If the service data flow is previously located in the second service data flow group, then based on the action indication in the request message, the PCF can update the group information of the service data flow, remove the service data flow from the second service data flow group, and add the service data flow to the first service data flow group, and can determine that the service data flow belongs to the first service data flow group and does not belong to the second service data flow group.

In yet another possible implementation, in a case that the PCF receives the request message sent by the AF, the request message includes the group identifier associated with the first service data flow group, and the request message also includes the action indication corresponding to the service data flow, then if the service data flow does not belong to any service data flow group before the PCF receives the request message sent by the AF, the action indication can be used to indicate adding the service data flow to the first service data flow group.

In some embodiments, in a case that the PCF receives the request message sent by the AF, the request message includes the group identifier, the group identifier is associated with the second service data flow group, and the request message further includes the action indication corresponding to the service data flow, the action indication can be used to indicate removing the service data flow from the second service data flow group.

In an embodiment of the present disclosure, in a case where the request message includes the group identifier corresponding to the service data flow, the group identifier is associated with the second service data flow group, and the request message further includes the action indication corresponding to the service data flow, the action indication can be used to indicate removing the service data flow from the second service data flow group.

It can be understood that in case that the PCF receives the request message sent by the AF, the request message includes the group identifier corresponding to the service data flow, the group identifier is associated with the second service data flow group, the request message further includes the action indication corresponding to the service data flow, and the action indication indicates removing the service data flow from the second service data flow group, then no matter in which service data flow group the service data flow is previously located, the PCF can determine to remove the service data flow from the second service data flow group based on the action indication in the request message.

It should be noted that before the PCF receives the request message sent by the AF, the service data flow may be located in the second service data flow group, or may also be located in any service data flow group other than the second service data flow group.

In an embodiment of the present disclosure, when the PCF receives the request message sent by the AF, the PCF may directly receive the request message sent by the AF, or may indirectly receive the request message sent by the AF.

In some embodiments, receiving by the PCF, the request message sent by the AF, includes:
receiving the request message sent by the AF through a network exposure function (NEF); or
receiving the request message sent by the AF through a time sensitive communication and time synchronization function (TSCTSF); or receiving the request message sent by the AF through the NEF and the TSCFSF.

In an embodiment of the present disclosure, for receiving the request message sent by the AF, the PCF can receive the request message sent by the AF through the NEF.

In an embodiment of the present disclosure, for receiving the request message sent by the AF, the PCF can receive the request message sent by the AF through the TSCFSF.

In an embodiment of the present disclosure, for receiving the request message sent by the AF, the PCF can receive the request message sent by the AF through the NEF and the TSCFSF.

In some embodiments, receiving by the PCF, the request message sent by the AF, includes: receiving an AF session create request or an AF session update request sent by the AF, wherein the AF session create request or the AF session update request includes the request message.

In an embodiment of the present disclosure, when the PCF receives the request message sent by the AF, the PCF can receive the AF session create request sent by the AF, wherein the AF session create request includes the request message.

In an embodiments of the present disclosure, when the PCF receives the request message sent by the AF, the PCF can receive the AF session update request sent by the AF, wherein the AF session update request includes the request message.

In some embodiments, receiving by the PCF, the request message sent by the AF, includes: receiving the request message sent by the AF in at least one procedure of:
a setting up an AF session procedure;
an AF session update procedure;
a service specific parameter provisioning procedure; or
a procedure of setting a policy for a further AF session.

In an embodiment of the present disclosure, when the PCF receives the request message sent by the AF, the PCF can receive the request message sent by the AF in the setting up an AF session procedure.

In an embodiment of the present disclosure, when the PCF receives the request message sent by the AF, the PCF can receive the request message sent by the AF in the AF session update procedure.

In an embodiment of the present disclosure, when the PCF receives the request message sent by the AF, the PCF can receive the request message sent by the AF in the service specific parameter provisioning procedure.

In an embodiment of the present disclosure, when the PCF receives the request message sent by the AF, the PCF can receive the request message sent by the AF in the procedure of setting a policy for a further AF session.

It should be noted that the above embodiments are not exhaustive and are only illustrative of partial embodiments. The above embodiments can be implemented separately, or multiple embodiments may be combined for implementation. The above embodiments are only illustrative and do not serve as specific limitations on the scope of protection of the embodiments of the present disclosure.

S32, generating or updating a policy and charging control (PCC) rule according to the request message.

In an embodiment of the present disclosure, the PCF can determine the service data flow group to which the service data flow belongs based on the request message, and then generate or update the PCC rule. Therefore, the PCF can make more reasonable policy decisions and resource authorizations for the service data flows, ensuring the consistency of policy decisions for service data flows belonging to the same service data flow group.

In an embodiment of the present disclosure, the PCF generates or updates the PCC rule based on the request message, and can further send the generated or updated PCC rule to SMF for installation and execution.

Optionally, the SMF can generate the corresponding QoS rule based on the generated or updated PCC rule sent by the PCF, and send the QoS rule to UPF and RAN for installation and execution.

By implementing the embodiments of the present disclosure, the PCF receives the request message sent by the AF and generates or updates the PCC rule based on the request message. Thus, the PCF can determine the service data flow group to which the service data flow belongs, and generate or update the corresponding PCC rule, which can make more reasonable policy decisions and resource authorizations for the service data flows, ensuring consistency in policy decisions for service data flows belonging to the same service data flow group.

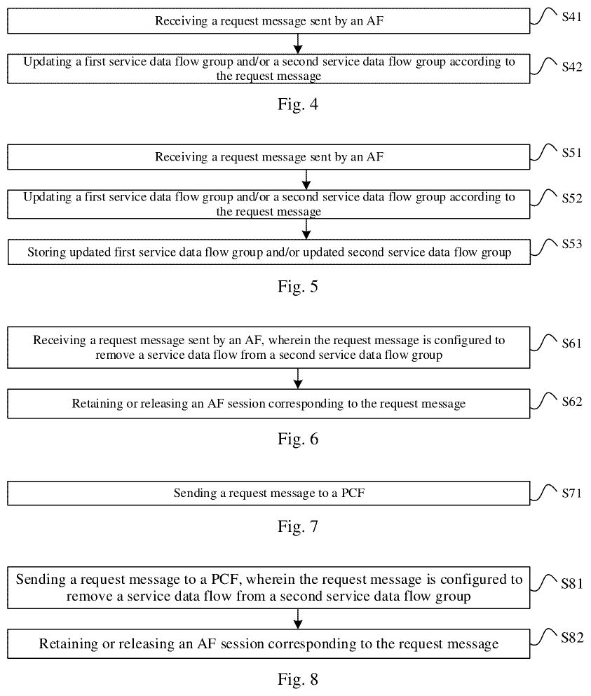

Please refer to FIG. 4, which is a flowchart of another method for managing a multimodal service data flow provided in an embodiment of the present disclosure. The method is performed by a PCF, and as shown in FIG. 4, the method may include but is not limited to the following steps.

S41, receiving a request message sent by an AF.

The request message is configured to indicate at least one of:

adding a service data flow to a first service data flow group; or removing a service data flow from a second service data flow group.

The relevant description of S41 can be found in the above embodiments, and will not be repeated here.

S42, updating the first service data flow group and/or the second service data flow group according to the request message.

In an embodiment of the present disclosure, the PCF receives the request message sent by the AF, wherein the request message is configured to indicate adding the service data flow to the first service data flow group. Based on this, the PCF can update the first service data flow group based on the request message.

In an embodiment of the present disclosure, the PCF receives the request message sent by the AF, wherein the request message is configured to indicate removing the service data flow from the second service data flow group. Based on this, the PCF can update the second service data flow group based on the request message.

In an embodiment of the present disclosure, the PCF receives the request message sent by the AF, wherein the request message is configured to indicate adding the service data flow into the first service data flow group and removing the service data flow from the second service data flow group. Based on this, the PCF can update the first service data flow group and the second service data flow group based on the request message.

It should be noted that in embodiments of the present disclosure, S41-S42 can be implemented separately or in combination with any other step in embodiments of the present disclosure, such as in combination with S31 to S32 in embodiments of the present disclosure, which is not limited in embodiments of the present disclosure.

By implementing the embodiments of the present disclosure, the PCF receives the request message sent by the AF and updates the first service data flow group and/or the second service data flow group based on the request message. Thus, the PCF can determine the service data flow group to which the service data flow belongs, in order to make more reasonable policy decisions and resource authorizations for the service data flow when the PCC rule is generated and updated, ensuring the consistency of policy decisions for service data flows belonging to the same service data flow group.

Please refer to FIG. 5, which is a flowchart of yet another method for managing a multimodal service data flow provided in an embodiment of the present disclosure. The method is performed by a PCF, and as shown in FIG. 5, the method may include but is not limited to the following steps.

S51, receiving a request message sent by an AF.

The request message is configured to indicate at least one of:
adding a service data flow into a first service data flow group; or
removing a service data flow from a second service data flow group.

S52, updating the first service data flow group and/or the second service data flow group according to the request message.

The relevant descriptions of S51 and S52 can be found in the above embodiments, and will not be repeated here.

S53, storing the updated first service data flow group and/or second service data flow group.

In an embodiment of the present disclosure, in a case where the PCF receives the request message sent by the AF, and the request message is configured to indicate adding the service data flow into the first service data flow group, the PCF can update the first service data flow group according to the request message, and store the updated first service data flow group.

In an embodiment of the present disclosure, in a case where the PCF receives the request message sent by the AF, and the request message is configured to indicate removing the service data flow from the second service data flow group, the PCF can update the second service data flow group according to the request message, and store the updated second service data flow group.

In an embodiment of the present disclosure, in a case where the PCF receives the request message sent by the AF, and the request message is configured to indicate adding the service data flow into the first service data flow group and removing the service data flow from the second service data flow group, the PCF can update the first service data flow group and the second service data flow group according to the request message, and store the updated first service data flow group and the updated second service data flow group.

In some embodiments, the PCF stores the updated first service data flow group and/or the updated second service data flow group into at least one of:
a local storage;
a unified data repository (UDR);
a unified data management function (UDM); or
an unstructured data storage function (UDSF).

In an embodiment of the present disclosure, the PCF can store the updated first service data flow group and/or the updated second service data flow group into a local storage.

In an embodiment of the present disclosure, the PCF can store the updated first service data flow group and/or the updated second service data flow group into a unified data repository (UDR).

In an embodiment of the present disclosure, the PCF can store the updated first service data flow group and/or the updated second service data flow group into an unstructured data storage function (UDSF).

It should be noted that in embodiments of the present disclosure, S51 to S53 can be implemented separately or in combination with any other step in embodiments of the present disclosure, such as in combination with S31 to S32 and/or S41 to S42 in embodiments of the present disclosure, which is not limited in embodiments of the present disclosure.

By implementing the embodiments of the present disclosure, the PCF receives the request message sent by the AF, updates the first service data flow group and/or the second service data flow group based on the request message, and stores the updated first service data flow group and/or the updated second service data flow group. Thus, the PCF can determine the service data flow group to which the service data flow belongs, and update and store the service data flow group, in order to make more reasonable policy decisions and resource authorizations for the service data flow when the PCC rule is generated and updated, ensuring the consistency of policy decisions for service data flows belonging to the same service data flow group.

Please refer to FIG. 6, which is a flowchart of yet another method for managing a multimodal service data flow provided in an embodiment of the present disclosure. The method is performed by a PCF, and as shown in FIG. 6, the method may include but is not limited to the following steps.

S61, receiving a request message sent by an AF, wherein the request message is configured to indicate removing a service data flow from a second service data flow group.

The relevant description of S61 can be found in the embodiments above and will not be repeated here.

S62, retaining or releasing an AF session corresponding to the request message.

In an embodiment of the present disclosure, the PCF receives the request message sent by the AF, wherein the request message is configured to indicate removing the service data flow from the second service data flow group. In this case, the PCF can retain or release the AF session corresponding to the request message.

It should be noted that in embodiments of the present disclosure, S51 to S53 can be implemented separately or in combination with any other step in embodiments of the present disclosure, such as in combination with S31 to S32 and/or S41 to S42 and/or S51 to S53 in embodiments of the present disclosure, which is not limited in embodiments of the present disclosure.

By implementing the embodiments of the present disclosure, the PCF receives the request message sent by the AF, wherein the request message is configured to indicate removing the service data flow from the second service data flow group, and retains or releases the AF session corresponding to the request message. Thus, the PCF can remove the service data flow from the second service data flow group according to the request message, and retain or release the AF session corresponding to the request message.

Please refer to FIG. 7, which is a flowchart of a method for managing a multimodal service data flow provided in an embodiment of the present disclosure. The method is performed by an AF, and as shown in FIG. 7, the method may include but is not limited to following steps.

S71, sending a request message to a PCF.

In an embodiment of the present disclosure, the AF can send the request message to the PCF.

The request message is configured to indicate at least one of:
adding a service data flow into a first service data flow group; or
removing a service data flow from a second service data flow group.

In an embodiment of the present disclosure, the AF can send the request message to the PCF, wherein the request message is configured to indicate adding the service data flow into the first service data flow group. Thus, the AF can send information to the PCF that the service data flow belongs to the first service data flow group.

In an embodiment of the present disclosure, the AF can send the request message to the PCF, wherein the request message is configured to indicate removing the service data flow from the second service data flow group. Thus, the AF can send information to the PCF that the service data flow does not belong to the second service data flow group.

In an embodiment of the present disclosure, the AF can send the request message to the PCF, wherein the request message is configured to indicate adding the service data flow into the first service data flow group and removing the service data flow from the second service data flow group. Thus, the AF can send information to the PCF that the service data flow belongs to the first service data flow group and does not belong to the second service data flow group.

It can be understood that the AF can send the request message to the PCF, and the request message can indicate adding one or more service data flows to the first service data flow group. Thus, the AF can send information about the first service data flow group to which one or more service data flows belong to the PCF.

It can be understood that the AF can send the request message to the PCF, and the request message can indicate removing one or more service data flows from the second service data flow group. Thus, the AF can send information about the second service data flow group to which one or more service data flows do not belong to the PCF.

It can be understood that the AF can send the request message to the PCF, and the request message can indicate adding one or more service data flows to the first service data flow group and removing the one or more service data flows from the second service data flow group. Thus, the AF can send information about the first service data flow group to which the one or more service data flows belong and the second service data flow group to which they do not belong to the PCF.

In some embodiments, the request message includes a group identifier corresponding to the service data flow, and the group identifier is associated with the first service data flow group or the second service data flow group.

In an embodiment of the present disclosure, the AF sends the request message to the PCF, and the request message includes the group identifier corresponding to the service data flow.

The group identifier may be a common identifier (common ID), or may be an XRM service identifier (XRM service ID). The common ID or XRM service ID can indicate different groups through different values, which is not specifically limited in embodiments of the present disclosure.

In an embodiment of the present disclosure, the group identifier may be associated with the first service data flow group, or the group identifier may also be associated with the second service data flow group.

It can be understood that the request message is used to indicate adding the service data flow to the first service data flow group and/or removing the service data flow from the second service data flow group.

In the request message, the group identifier corresponding to the service data flow is included. When the group identifier is associated with the first service data flow group, the request message can be used to indicate adding the service data flow to the first service data flow group and/or removing the service data flow from the second service data flow group.

In a case where the request message includes the group identifier corresponding to the service data flow, and the group identifier is associated with the second service data flow group, the request message can be used to indicate adding the service data flow to the first service data flow group and/or removing the service data flow from the second service data flow group.

In a possible implementation, the AF may send the request message to the PCF, which includes the group identifier associated with the first service data flow group. The request message may be used to indicate adding the service data flow to the first service data flow group.

In another possible implementation, the AF may send the request message to the PCF, which includes the group identifier associated with the first service data flow group. If the service data flow does not belong to any service data flow group before receiving the request message sent by the AF, the request message can be used to indicate adding the service data flow to the first service data flow group.

In another possible implementation, the AF may send the request message to the PCF, which includes the group identifier associated with the second service data flow group. The request message can be used to indicate removing the service data flow from the second service data flow group.

In another possible implementation, the AF may send the request message to the PCF, which includes the group identifier associated with the first service data flow group. If the service data flow is located in the second service data flow group before receiving the request message sent by the AF, the request message can be used to indicate adding the service data flow to the first service data flow group and removing the service data flow from the second service data flow group.

In some embodiments, before the AF sends the request message to the PCF, the service data flow is located in the second service data flow group, or the service data flow does not belong to any service data flow group.

In an embodiment of the present disclosure, if the service data flow is located in the second service data flow group before the AF sends the request message to the PCF, then in a case where the AF sends the request message to the PCF, the request message includes the group identifier corresponding to the service data flow, and the group identifier is associated with the first service data flow group, the request message may indicate removing the service data flow from the second service data flow group. In addition, the request message may also indicate adding the service data flow into the first service data flow group.

In an embodiment of the present disclosure, if the service data flow does not belong to any service data flow group before the AF sends the request message to the PCF, then in a case where the AF sends the request message to the PCF, the request message includes the group identifier corresponding to the service data flow, and the group identifier is associated with the first service data flow group, the request message may indicate adding the service data flow into the first service data flow group.

In some embodiments, the request message includes an action indication corresponding to the service data flow.

In an embodiment of the present disclosure, the request message includes the action indication corresponding to the service data flow.

In an embodiment of the present disclosure, the AF sends the request message to the PCF, the request message includes the group identifier, the group identifier is associated with the first service data flow group or the second service data flow group, and the request message further includes the action indication corresponding to the service data flow.

The action indication may indicate at least one of:
adding the service data flow into the first service data flow group; or
removing the service data flow from the second service data flow group.

In a possible implementation, in a case that the AF sends the request message to the PCF, the request message includes the group identifier associated with the first service data flow group, and the request message further includes the action indication corresponding to the service data flow, the action indication can be used to indicate adding the service data flow to the first service data flow group.

It can be understood that in case that the AF sends the request message to the PCF, the request message includes the group identifier corresponding to the service data flow, the group identifier is associated with the first service data flow group, the request message further includes the action indication corresponding to the service data flow, and the action indication indicates adding the service data flow into the first service data flow group, then no matter whether the service data flow is previously in the service data flow group or in which service data flow group, the PCF can determine to add the service data flow to the first service data flow group based on the action indication in the request message.

If the service data flow is previously located in the first service data flow group, the PCF may not update group information of the service data flow, and may determine that the service data flow belongs to the first service data flow group.

In another possible implementation, in a case that the AF sends the request message to the PCF, the request message includes the group identifier associated with the second service data flow group, and the request message further includes the action indication corresponding to the service data flow, the action indication can be used to indicate removing the service data flow from the second service data flow group.

If the service data flow is previously located in the second service data flow group, the PCF may update group information of the service data flow based on the action indication in the request message, and may determine that the service data flow does not belong to the second service data flow group.

If the service data flow is previously located in a group other than the second service data flow group, the PCF may not update group information of the service data flow, and may determine that the service data flow does not belong to the second service data flow group.

In yet another possible implementation, in a case that the AF sends the request message to the PCF, the request message includes the group identifier associated with the first service data flow group, and the request message also includes the action indication corresponding to the service data flow, then if the service data flow belongs to the second service data flow group before the AF sends the request message to the PCF, the action indication can be used to indicate removing the service data flow from the second service data flow group, and in addition, the action indication can also be used to indicate adding the service data flow into the first service data flow group.

If the service data flow is previously located in the second service data flow group, then based on the action indication in the request message, the PCF can update the group information of the service data flow, remove the service data flow from the second service data flow group, and add the service data flow to the first service data flow group, and can determine that the service data flow belongs to the first service data flow group and does not belong to the second service data flow group.

In yet another possible implementation, in a case that the AF sends the request message to the PCF, the request message includes the group identifier associated with the first service data flow group, and the request message also includes the action indication corresponding to the service data flow, then if the service data flow does not belong to any service data flow group before the AF sends the request message to the PCF, the action indication can be used to indicate adding the service data flow to the first service data flow group.

In some embodiments, in a case that the AF receives the request message sent by the AF, the request message includes the group identifier, the group identifier is associated with the second service data flow group, and the request message further includes the action indication corresponding to the service data flow, the action indication can be used to indicate removing the service data flow from the second service data flow group.

In an embodiment of the present disclosure, in a case where the request message includes the group identifier corresponding to the service data flow, the group identifier is associated with the second service data flow group, and the request message further includes the action indication corresponding to the service data flow, the action indication can be used to indicate removing the service data flow from the second service data flow group.

It can be understood that in case that the AF sends the request message to the PCF, the request message includes the group identifier corresponding to the service data flow, the group identifier is associated with the second service data flow group, the request message further includes the action indication corresponding to the service data flow, and the action indication indicates removing the service data flow from the second service data flow group, then no matter in which service data flow group the service data flow is previously located, the PCF can determine to remove the service data flow from the second service data flow group based on the action indication in the request message.

It should be noted that before the AF sends the request message to the PCF, the service data flow may be located in the second service data flow group, or may also be located in any service data flow group other than the second service data flow group.

In an embodiment of the present disclosure, when the AF sends the request message to the PCF, the AF may directly send the request message to the PCF, or may indirectly send the request message to the PCF.

In some embodiments, sending by the AF, the request message to the PCF, includes:
sending the request message to the PCF through a network exposure function (NEF); or
sending the request message to the PCF through a time sensitive communication and time synchronization function (TSCTSF); or
sending the request message to the PCF through the NEF and the TSCFSF.

In an embodiment of the present disclosure, for sending the request message to the PCF, the AF can send the request message to the PCF through the NEF.

In an embodiment of the present disclosure, for sending the request message to the PCF, the AF can send the request message to the PCF through the TSCFSF.

In an embodiment of the present disclosure, for sending the request message to the PCF, the AF can send the request message to the PCF through the NEF and the TSCFSF.

In some embodiments, sending by the AF, the request message to the PCF, includes: sending an AF session create request or an AF session update request to the PCF, wherein the AF session create request or the AF session update request includes the request message.

In an embodiment of the present disclosure, when the AF sends the request message to the PCF, the AF can send the AF session create request to the PCF, wherein the AF session create request includes the request message.

In an embodiments of the present disclosure, when the AF sends the request message to the PCF, the AF can send the AF session update request to the PCF, wherein the AF session update request includes the request message.

It can be understood that the AF can send the request message to PCF through the following procedure:
a procedure such as: the AF provides the RT latency requirement to the PCF during AF session with required QoS procedure;
a procedure such as AF session with required QoS update procedure;
a procedure such as Service specific parameter provisioning procedure;
a procedure such as: Set a policy for a future AF session procedure.

In some embodiments, sending by the AF, the request message to the PCF, includes: sending the request message to the PCF in at least one procedure of:
a setting up an AF session procedure;
an AF session update procedure;
a service specific parameter provisioning procedure; or
a procedure of setting a policy for a future AF session.

In an embodiment of the present disclosure, when the AF sends the request message to the PCF, the AF can send the request message to the PCF in the setting up an AF session procedure.

In an embodiment of the present disclosure, when the AF sends the request message to the PCF, the AF can send the request message to the PCF in the AF session update procedure.

In an embodiment of the present disclosure, when the AF sends the request message to the PCF, the AF can send the request message to the PCF in the service specific parameter provisioning procedure.

In an embodiment of the present disclosure, when the AF sends the request message to the PCF, the AF can send the request message to the PCF in the procedure of setting a policy for a further AF session.

It should be noted that the above embodiments are not exhaustive and are only illustrative of partial embodiments. The above embodiments can be implemented separately, or multiple embodiments may be combined for implementation. The above embodiments are only illustrative and do not serve as specific limitations on the scope of protection of the embodiments of the present disclosure.

By implementing the embodiments of the present disclosure, the AF sends the request message to the PCF, wherein the request message is configured to indicate adding the service data flow into the first service data flow group and/or removing the service data flow from the second service data flow group. Thus, the AF can send information for determining the service data flow group to which the service data flow belongs to the PCF, and the PCF can generate or update the corresponding PCC rule according to the information of the service data flow group to which the service data flow belongs, which can make more reasonable policy decisions and resource authorizations for the service data flow, ensuring consistency in policy decisions for service data flows belonging to the same service data flow group.

Please refer to FIG. 8, which is a flowchart of another method for managing a multimodal service data flow provided in an embodiment of the present disclosure. The method is performed by an AF, and as shown in FIG. 8, the method may include but is not limited to the following steps.

S81, sending a request message to a PCF, wherein the request message is configured to indicate removing a service data flow from a second service data flow group.

The relevant description of S81 can be found in the above embodiments, and will not be repeated here.

S82, retaining or releasing an AF session corresponding to the request message.

In an embodiment of the present disclosure, the AF sends the request message to the PCF, wherein the request message is configured to indicate removing the service data flow from the second service data flow group. In this case, the AF can retain or release the AF session corresponding to the request message.

It should be noted that in embodiments of the present disclosure, S81 to S82 can be implemented separately or in combination with any other step in embodiments of the present disclosure, such as in combination with S71 in embodiments of the present disclosure, which is not limited in embodiments of the present disclosure.

By implementing the embodiments of the present disclosure, the AF sends the request message to the PCF, wherein the request message is configured to indicate removing the service data flow from the second service data flow group, and retains or releases the AF session corresponding to the request message. Thus, the AF can send the request message to the PCF, indicating to remove the service data flow from the second service data flow group, and retain or release the AF session corresponding to the request message.

For the convenience of understanding embodiments of the present disclosure, the following exemplary embodiments are provided.

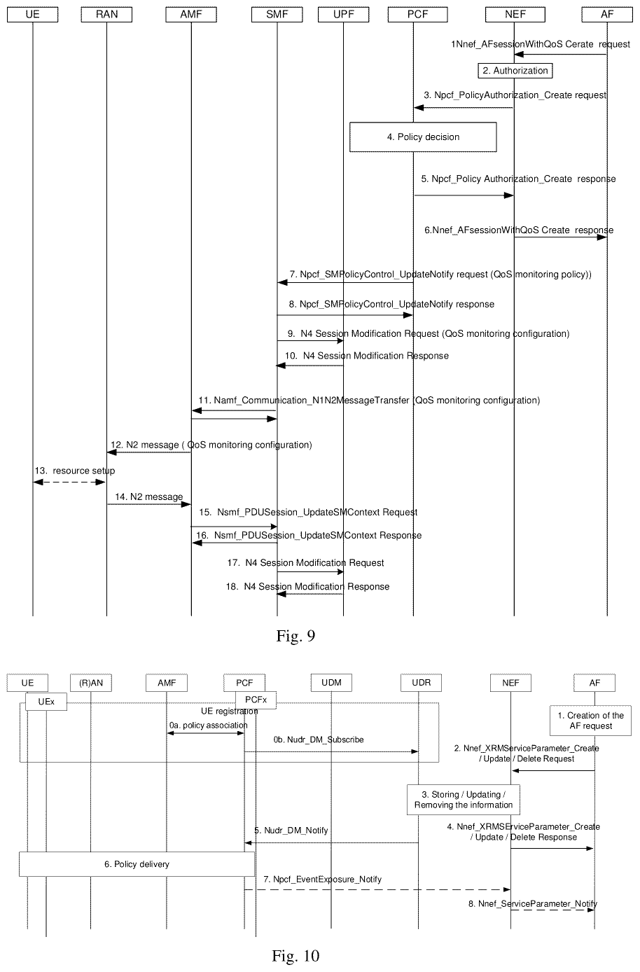

An exemplary embodiment is as shown in FIG. 9.
1. The AF sends an AF session resource request, for example, creates an AF request through Nnef-AFSsession WithQoS_Create request. The request message can carry a common ID or XRM service ID, as well as an action indication. The action indication indicates increasing or decreasing the number of service data flows (SDFs) in the group.

The common ID identifies the XRM service data flow group, and SDFs carrying the same common ID belong to the same XRM service group. Optionally, UE address/UE identifier, AF identifier application ID, data network name (DNN), single network slice selection assistance information (S-NSSAI), QoS parameters, and other relevant information are carried.
2. The NEF authorizes the AF request. If it is a non trusted AF, the AF request can be sent to the PCF through the NEF. (Optionally, the NEF can perform relevant mappings, including mapping from identifying XRM service (AF Service Identifier) to DNN and S-NSSAI, and mapping from external applications to identifying applications in the Core Network (CN); and based on UDM subscription information, mapping from external UE identifiers to UE identifiers within CN (such as SUPI), and mapping from external to internal XRM service group identifiers based on UDM subscription information)
3. The NEF authorizes the AF request and determines whether to invoke the TSCTSF or to directly contact the PCF depending on the parameters provided by the AF. These signaling steps are the same as for TS 23.502 clause 4.15.6.6 for setting up an AF session with required QoS procedure. The PCF receives the AF provided attributes from NEF or from TSCTSF. The NEF triggers the Npcf_Policy Authorization_Create request to send the AF request to the PCF, carrying Common ID (or XRM service ID) and action indication, for the PCF's reference in policy decision-making.
4. The PCF makes a policy decision. The PCF may determine that the updated or new policy information need to be sent to the SMF.

The PCF receives the AF session (create/update) request, and considering common ID (or XRM service ID), and action indication, can generate or update the PCC rule.

Optionally, the PCF can update the group information associated with the common ID.

Optionally, the updated group information is stored locally or in UDR, UDM, or UDSF.

Optionally, the action indication can be carried as an indication explicitly, or implicitly carried by deleting or replacing the original common ID in the corresponding SDF in the AF request with a different common ID, indicating that the SDF is removed from the original group.

Optionally, the SDF is removed from the group associated with the original common ID, and the corresponding AF session can be retained or released.

The PCF can send the generated/updated corresponding PCC rule to SMF for installation and execution; the SMF can generate the corresponding QoS rule and send the QoS rule to UPF and RAN for installation and execution. This section can be found in the description of related technologies.
5. The PCF responds to the NEF a Npcf_Policy Authorization_Create response.
6. The NEF sends a Nnef_AFsession WithQoS_Create response message to the AF, carrying a result to indicate whether the request is authorized.
7. The PCF initiates SM Policy Association Modification Request (PCC rule (QOS monitoring policy)) to the SMF.

Based on the QoS monitoring policy for measurement from the PCF, the SMF generates the QoS Monitoring configuration for UPF (and for RAN, if needed), as described in step 4.
8. The SMF replies SM Policy Association Modification Response to the PCF.
9. The SMF initiates N4 Session Modification Request (QOS Monitoring configuration) to the UPF.
10. Upon reception of QoS Monitoring configuration, the UPF enables the measurement and report. The UPF(s) respond to the SMF.
11. For SMF requested modification, the SMF invokes Namf_Communication_N1N2MessageTransfer ([N2 SM information] (PDU Session ID, QFI(s), QoS Profile(s), QoS Monitoring configuration), N1 SM container)).
12. The AMF may send N2 ([N2 SM information received from SMF], NAS message (PDU Session ID, N1 SM container (PDU Session Modification Command))) Message to the (R)AN. Upon reception of QoS Monitoring configuration, the RAN enables the event measurement and report.
14. The (R)AN may acknowledge N2 PDU Session Request by sending a N2 PDU Session Ack Message to the AMF.
15. The AMF forwards the N2 SM information received from the AN to the SMF via Nsmf_PDUSession_UpdateSMContext service operation.
16. The SMF replies with a Nsmf_PDUSession_UpdateSMContext Response.
17-18. The SMF may update N4 session of the UPF(s) that are involved by the PDU Session Modification by sending N4 Session Modification Request message to the UPF. When the PCF receives the QoS Monitoring report subsequently, it will notify the report to the AF.

The AF provides the XRM service request to the PCF. This embodiment describes 1) using setting up an AF session with required QoS procedure. It can also be provided through the following procedure:
2) or an AF session with required QoS update procedure; (update procedure)
3) or Service specific parameter provisioning; (2.2.2 service specific parameter provisioning procedure)
4) or set a policy for a future AF session; (Pre-set a policy before AF session request).

An exemplary embodiment is as shown in FIG. 10. In this embodiment of the present disclosure, the AF provides a common ID (or XRM service ID) to PCF through NEF, while carrying an action indication indicating increasing or decreasing the number of SDFs in the group, supporting PCF's authorization of relevant data flows of XRM service.

As shown in FIG. 10, in step 0, some or all of the UEs related to XRM services or multimodal data services have registered with the network and selected PCF to complete AM session association. The PCF can subscribe to UDM for change notifications of XRM service or multimodal data service related subscription information based on policies and QoS requirements of XRM service.
1. AF can trigger the Nnef-XRMServiceParameter service, creating an AF request that includes information such as XRM service identifier, common ID, UE address or identifier. AF carries a common ID (or XRM service ID) and an action indication in the request message, where the indication indicates increasing or decreasing the number of SDFs in the group.

AF provides XRM service or multiple data service specific parameters to single or multiple UE related to the service through Nnef-XRMServiceParameter service. The information sent by AF includes common ID, service parameters, UE/UE group, and subscription to events, which are specifically:
1) service description, identifying XRM service or XRM service data; which can be identified by a combination of DNN and S-NSSAI, or by XRM ID; or can be represented by AF Service Identifier or external Application Identifier.
2) service parameters: information on the AF guidance for XRM service or multimodal data Service related Policy and QoS determination, a list of rules that associate XRM service or multiple data Service application traffic, UE policy, common ID or Group ID, or a combination of DNN and S-NSSAI, SSC mode, priorities of corresponding rules (such as Alternative QoS parameter priority, corresponding location or Time Window priority, corresponding inclusion type or routing selection priority, etc.).
3) A single UE or multiple UEs (Group UE) related to the XRM service or multiple data service associated with the AF request.
4) Subscription to events. The AF may subscribe to notifications about the outcome of the SM policy or AM policy or UE Policy's execution and change; or subscription to events of media data flows related to XRM service, e.g. date rate, latency.

When AF needs to update and delete corresponding request or subscription, the AF request update and deletion process can also be initiated through this service.
2. AF can send the request to NEF. NEF authorizes the AF request. NEF performs relevant mappings, including mapping from XRM service or XRM data service (AF Service Identifier) to DNN and S-NSSAI, and mapping from external applications to CN application identifiers; and based on UDM subscription information, mapping from external UE identifiers to UE identifiers within CN (such as SUPI), as well as mapping from external to internal XRM service group identifiers based on UDM subscription information;
3. NEF can store requested information in UDR (for example, as service characteristic parameter information storage for Application Data). Optionally, NEF may refine corresponding service parameters based on local configuration.

Optionally, based on operator policies, and in combination with subscription information, the NEF can confirm whether the requested service characteristics can be authorized and store the corresponding parameters in UDR for XRM service or multimodal data service of a single UE or multiple UEs in a group.

If multiple UEs are involved, the NEF transmits relevant service parameters to the PCF, executes corresponding authorizations in each PCF, and makes decisions or updates on policies and rules. PCF stores the corresponding information in UDR based on the request authorization result. (Support single PCF and multi PCF scenarios)

In multi UE scenarios, the subscription data (Special QoS profile) of UE group members can be associated through XRM service indication or Group ID/Common ID;

Consumers such as AF or PCF can subscribe to relevant XRM services or multimodal data related event trigger through NEF, such as QoS monitoring report, Service QoS update, UE relocation, PCF change, etc.

AF or PCF, etc., obtain corresponding notification by receiving NEF report; perform updates to subsequent application requirements or QoS rules.
4. NEF returns a create request response message to AF.

If in step 0, PCF performs a subscription information update notification after UE registration, then the subsequent process is executed because AF request updates UDR subscription information.
5. PCF receives UDR's notification of change in subscription information.

PCF updates the group information associated with this common ID; optionally, stores the updated group information locally or in UDR, UDM, or UDSF.

Optionally, the action indication can be carried as an indication explicitly, or implicitly carried by deleting or replacing the original common ID in the corresponding SDF in the AF request with a different common ID, indicating that the SDF is removed from the original group;

Optionally, the SDF is removed from the group associated with the original common ID, and the corresponding AF session can be retained or released.
6. PCF transmits UE policy to UE.
7. If AF subscribes to execution notifications of XRM service related policies, PCF sends the relevant execution results to AF through NEF. Moreover, if there are changes in the relevant subscription parameters, PCF updates changes to UDR, triggering policy changes and collaboration in the serving PCFs of other UEs related to the XRM service group.
8. After receiving the notification, NEF first performs the mapping of internal and external related parameters, and then reports the relevant information to AF.

In the above embodiments provided in this disclosure, the solutions provided in this disclosure are introduced from the perspectives of AF and PCF, respectively. It can be understood that each device includes corresponding hardware structures and/or software modules to perform the above functions. Technicians in this field should easily realize that, based on the algorithm steps described in the embodiments disclosed in this article, this disclosure can be implemented in the form of hardware or a combination of hardware and computer software. Whether a certain function is executed through hardware or computer software driven hardware depends on the specific application and design constraints of the technical solution. Professional technicians can use different methods to achieve the described functionality for each specific application, but such implementation should not be considered beyond the scope of this disclosure.

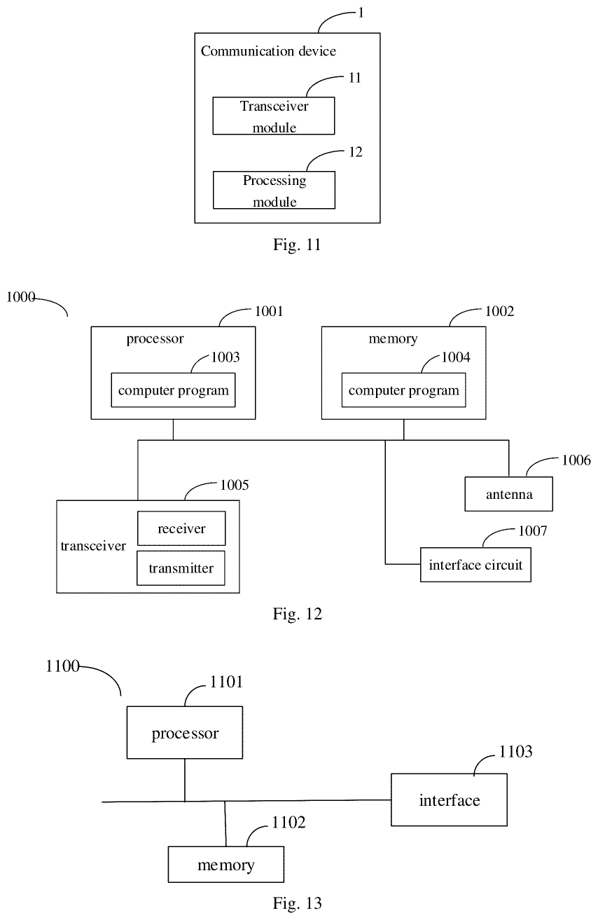

Please refer to FIG. 11, which is a block diagram of a communication device 1 provided in an embodiment of the present disclosure. The communication device 1 shown in FIG. 11 may include a transceiver module 11 and a processing module 12. The transceiver module 11 may include a sending module and/or a receiving module. The sending module is used to implement the sending function, and the receiving module is used to implement the receiving function. The transceiver module can implement the sending function and/or the receiving function.

The communication device 1 is arranged on a PCF side, and includes a transceiver module 11 and a processing module 12.

The transceiver module 11 is configured to receive a request message sent by an application function (AF), wherein the request message is configured to indicate at least one of:
adding a service data flow to a first service data flow group; or
removing a service data flow from a second service data flow group.

The processing module 12 is configured to generate or update a policy and charging control (PCC) rule according to the request message.

In some embodiments, the request message includes a group identifier corresponding to the service data flow, and the group identifier is associated with the first service data flow group or the second service data flow group.

In some embodiments, the request message includes an action indication corresponding to the service data flow.

In some embodiments, in a case where the group identifier is associated with the first service data flow group, the action indication indicates at least one of:

adding the service data flow to the first service data flow group; or removing the service data flow from the second service data flow group.

In some embodiments, before receiving the request message sent by the AF, the service data flow is located in the second service data flow group, or does not belong to any service data flow group.

In some embodiments, in a case where the group identifier is associated with the second service data flow group, the action indication indicates to remove the service data flow from the second service data flow group.

In some embodiments, the processing module 12 is further configured to update the first service data flow group and/or the second service data flow group according to the request message.

In some embodiments, the processing module 12 is further configured to store updated first service data flow group and/or updated second service data flow group into at least one of:
a local storage;
a unified data repository (UDR);
a unified data management function (UDM); or
an unstructured data storage function (UDSF).

In some embodiments, the processing module 12 is further configured to, in response to the request message indicating to remove the service data flow from the second service data flow group, retain or release an AF session corresponding to the request message.

In some embodiments, the transceiver module 11 is further configured to receive the request message sent by the AF through a network exposure function (NEF); or receive the request message sent by the AF through a time sensitive communication and time synchronization function (TSCTSF); or receive the request message sent by the AF through the NEF and the TSCFSF.

In some embodiments, the transceiver module 11 is further configured to receive an AF session create request or an AF session update request sent by the AF, wherein the AF session create request or the AF session update request includes the request message.

In some embodiments, the transceiver module 11 is further configured to receive the request message sent by the AF in at least one procedure of:
a setting up an AF session procedure;
an AF session update procedure;
a service specific parameter provisioning procedure; or

a procedure of setting a policy for a further AF session.

The communication device 1 is arranged on an AF side, and includes a transceiver module 11 and a processing module 12.

The transceiver module 11 is configured to send a request message to a PCF, wherein the request message is configured to indicate at least one of:
adding a service data flow to a first service data flow group; or
removing a service data flow from a second service data flow group.

In some embodiments, the request message includes a group identifier corresponding to the service data flow, and the group identifier is associated with the first service data flow group or the second service data flow group.

In some embodiments, the request message includes an action indication corresponding to the service data flow.

In some embodiments, in a case where the group identifier is associated with the first service data flow group, the action indication indicates at least one of:

adding the service data flow to the first service data flow group; or removing the service data flow from the second service data flow group.

In some embodiments, before sending the request message to the PCF, the service data flow is located in the second service data flow group, or does not belong to any service data flow group.

In some embodiments, in a case where the group identifier is associated with the second service data flow group, the action indication indicates to remove the service data flow from the second service data flow group.

In some embodiments, the processing module 12 is configured to, in response to the request message indicating to remove the service data flow from the second service data flow group, retain or release an AF session corresponding to the request message.

In some embodiments, the transceiver module 11 is further configured to send the request message to the PCF through a NEF; or send the request message sent to the PCF through a TSCTSF; or send the request message sent to the PCF through the NEF and the TSCFSF.

In some embodiments, the transceiver module 11 is further configured to send an AF session create request or an AF session update request to the PCF, wherein the AF session create request or the AF session update request includes the request message.

In some embodiments, the transceiver module 11 is further configured to send the request message to the PCF in at least one procedure of:
a setting up an AF session procedure;
an AF session update procedure;
a service specific parameter provisioning procedure; or
a procedure of setting a policy for a further AF session.

Regarding the communication device 1 in the above embodiment, the specific ways in which each module performs operations have been described in detail in the relevant embodiments of the method, and will not be elaborated here.

The communication device 1 provided in the above embodiments of the present disclosure achieves the same or similar beneficial effects as the methods for managing a multimodal service data flow provided in some of the above embodiments, which will not be repeated here.

Please refer to FIG. 12, which is a block diagram of another communication device 1000 according to an embodiment of the disclosure. The communication device 1000 may be a terminal, or may be a SMF, or may be a PCF. The device may be configured to implement the method described in the method embodiments. For details, please refer to descriptions in the method embodiments.

The communication device 1000 may include one or more processors 1001. The processor 1001 may be a general purpose processor or a dedicated processor. For example, the processor 1001 may be a baseband processor or a central processor. The baseband processor may be configured to process a communication protocol and communication data, and the central processor may be configured to control a communication device (e.g., a network side device, a baseband chip, a terminal, a terminal chip, a DU or CU, etc.), to execute a computer program, and process data of the computer program.

Optionally, the communication device 1000 may further include one or more memories 1002 with a computer program 1004 stored thereon. The memory 1002 executes the computer program 1004 so that the communication device 1000 performs the method as described in the above method embodiments. Optionally, the memory 1002 may further store data. The communication device 1000 and the memory 1002 may be independently configured or integrated together.

Optionally, the communication device 1000 may further include a transceiver 1005 and an antenna 1006. The transceiver 1005 may be referred to as a transceiver unit, a transceiver machine or a transceiver circuit, which may be configured to achieve a transceiving function. The transceiver 1005 may include a receiver and a transmitter. The receiver may be referred to as a receiver or a receiving circuit, etc., for implementing a receiving function; the transmitter may be referred to as a transmitter or a transmitting circuit, etc. for implementing a transmitting function.

Optionally, the communication device 1000 may further include one or more interface circuits 1007. The interface circuit 1007 is configured to receive code instructions and transmit the code instructions to the processor 1001. The processor 1001 runs the code instructions so that the communication device 1000 performs the method described in the above method embodiments.

In the case that the communication device 1000 is a PCF, the transceiver 1005 is configured to execute S31 in FIG. 3; S41 in FIG. 4; S51 in FIG. 5; S61 in FIG. 6; the processor 1001 is configured to execute S32 in FIG. 3; S42 in FIG. 4; S52 and S53 in FIG. 5; S62 in FIG. 6.

In the case that the communication device 1000 is an AF, the transceiver 1005 is configured to execute S71 in FIG. 7; S81 in FIG. 8; the processor 1001 is configured to execute S82 in FIG. 8.

In an implementation, the processor 1001 may include a transceiver configured to implement receiving and transmitting functions. For example, the transceiver may be a transceiver circuit, or an interface, or an interface circuit. The transceiver circuit, the interface or the interface circuit configured to implement receiving and transmitting functions may be separate or integrated together. The transceiver circuit, the interface or the interface circuit may be configured to read and write codes/data, or the transceiver circuit, the interface or the interface circuit may be configured to transmit or deliver a signal.

In an implementation, the processor 1001 may be stored with a computer program 1003. The computer program 1003 runs on the processor 1001 so that the communication device 1000 performs the method as described in the above method embodiments. The computer program 1003 may be solidified in the processor 1001, in which case the processor 1001 may be implemented by a hardware.

In an implementation, the communication device 1000 may include a circuit that may implement a transmitting or receiving or communication function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may further be fabricated by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe) and gallium arsenide (GaAs).

The communication device described in the above embodiments may be a terminal or a SMF, or a PCF, or a core network, but the scope of the communication device described in the disclosure is not limited thereto, and a structure of the communication device may not be subject to FIG. 12. The communication device may be a stand-alone device or may be a part of a larger device. For example, the communication device may be the following.
(1) a stand-alone integrated circuit (IC), or a chip, or a system on chip or a subsystem;
(2) a set of one or more ICs, optionally, which may also include a storage component for storing data and a computer program;
(3) an ASIC, such as a Modem;
(4) a module that may be embedded within other devices;
(5) a receiver, a terminal, a smart terminal, a cellular phone, a wireless device, a handset, a mobile unit, a vehicle device, a network device, a cloud device, an artificial intelligence device, etc. ; and
(6) others, and so forth.

In the case that the communication device may be a chip or a system on chip, please refer to FIG. 13, which is a block diagram of a chip provided in an embodiment of the disclosure.

As shown in FIG. 13, the chip 1100 includes a processor 1101 and an interface 1103, in which the number of processors 1101 may be one or more and the number of interfaces 1103 may be more than one.

For the case where the chip is used to implement the functionality of the terminal in embodiments of the disclosure:
the interface 1103 is configured for receiving code instructions and sending the code instructions to the processor;
the processor 1101 is configured for running the code instructions to perform the method for managing a multimodal service data flow as described in some embodiments above.

For the case where the chip is used to implement the functionality of the SMF in embodiments of the disclosure:
the interface 1103 is configured for receiving code instructions and sending the code instructions to said processor;
the processor 1101 is configured for running the code instructions to perform the method for managing a multimodal service data flow as described in some embodiments above.

For the case where the chip is used to implement the functionality of the PCF in embodiments of the disclosure:
the interface 1103 is configured for receiving code instructions and sending the code instructions to said processor;
the processor 1101 is configured for running the code instructions to perform the method for managing a multimodal service data flow as described in some embodiments above.

Optionally, the chip 1100 further includes a memory 1102, configured to save necessary computer program and data.

Those skilled in the related art may understand that, various illustrative logical blocks and steps listed in embodiments of the disclosure, may be implemented by an electronic hardware, a computer software or a combination of an electronic hardware and a computer software. Whether the function is implemented by the hardware or the software depends on specific applications and design requirements for an overall system. Those skilled in the art may implement the functions by using various methods for each specific application, but such an implementation should not be understood as beyond the protection scope of embodiments of the disclosure.

A system for managing a multimodal service data flow is further provided in embodiments of the disclosure. The system includes a communication device as a terminal, a communication device as a SMF, and a communication device as a PCF in the preceding embodiment of FIG. 11, or, alternatively, the system includes a communication device as a terminal, a communication device as a SMF and a communication device as a PCF in the preceding embodiment of FIG. 12.

A readable storage medium with instructions stored thereon is further provided in the disclosure. When the instructions are executed by a computer, functions in any method embodiment are implemented.

A computer program product is further provided in the disclosure. The computer program product implements functions of any method embodiment when executed by a processor.

In the above embodiments, the functions may be wholly or partially implemented by a software, a hardware, a firmware, or any combination thereof. When implemented by a software, the functions may be implemented in whole or in part in the form of a computer program product. The computer program product includes one or more computer programs. Procedures or functions according to embodiments of the disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another via wire (such as a coaxial cable, a fiber optic, a digital subscriber line (DSL)) or wireless (such as infrared, wireless, microwave). The computer-readable storage medium may be any available medium that may be accessed by a computer or a data storage device such as a server that integrates one or more of the available media, and a data center. The readable medium may be a magnetic medium (such as a floppy disk, a hard disk and a magnetic tape), an optical medium (such as a digital video disk (DVD)), or a semiconductor medium (such as a solid state disk (SSD)).

Unless otherwise required by the context, throughout the specification and claims, the term “comprise” and other forms such as the third person singular form “comprises” and the present participle form “comprising” are interpreted as open and inclusive, meaning “including, but not limited to”. In the description of the specification, the terms “some embodiments”, “exemplary embodiments”, etc. are intended to indicate that specific features, structures, materials, or characteristics related to the embodiments or examples are included in at least one embodiment or example disclosed herein. The schematic representation of the above terms does not necessarily refer to the same embodiment or example. In addition, the specific features, structures, materials, or characteristics described may be included in any appropriate manner in any one or more embodiments or examples.

Those skilled in the art may understand that various numbers such as first and second involved in disclosure are distinguished merely for convenience of description, and are not intended to limit the scope of embodiments of the disclosure, but also to indicate an order of precedence.

At least one in the disclosure may also be described as one or more, and a plurality of may be two, three, four or more, which is not limited in the disclosure. In embodiments of the disclosure, for a kind of technical feature, technical features in the kind of technical feature are distinguished by “first”, “second”, “third”, “A”, “B”, “C” and “D”, and there is no order of precedence or magnitude between technical features described in “first”, “second”, “third”, “A”, “B”, “C” and “D”. “A and/or B” includes the following three combinations: only A, only B, and a combination of A and B.

Those skilled in the related art may realize that, in combination with units and algorithm steps of the examples described in embodiments of the disclosure, may be implemented by an electronic hardware or a combination of an electronic hardware and a computer software. Whether the functions are executed by the hardware or the software depends on a specific application and a design constraint of the technical solution. Those skilled in the art may adopt different methods for each specific application to implement the described functions, but such implementation should not be considered beyond the scope of the disclosure.

Those skilled in the art may clearly understand that for convenience and clarity of description, a specific working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the disclosure. Therefore, the protection scope of the disclosure shall be subject to the protection scope of claims.

1. A method for managing a multimodal service data flow, performed by a policy control function (PCF), comprising:
receiving a request message sent by an application function (AF), wherein the request message is configured to indicate at least one of:
adding a service data flow to a first service data flow group; or
removing a service data flow from a second service data flow group; and
generating or updating a policy and charging control (PCC) rule according to the request message.

2. The method of claim 1, wherein the request message comprises a group identifier corresponding to the service data flow, and the group identifier is associated with the first service data flow group or the second service data flow group;
wherein the request message comprises an action indication corresponding to the service data flow.

3. (canceled)

4. The method of claim 2, wherein in a case where the group identifier is associated with the first service data flow group, the action indication indicates at least one of:
adding the service data flow to the first service data flow group; or
removing the service data flow from the second service data flow group.

5. The method of claim 4, wherein before receiving the request message sent by the AF, the service data flow is located in the second service data flow group, or does not belong to any service data flow group.

6. The method of claim 2, wherein in a case where the group identifier is associated with the second service data flow group, the action indication indicates to remove the service data flow from the second service data flow group.

7. The method of claim 1, further comprising:
updating at least one of the first service data flow group or the second service data flow group according to the request message.

8. The method of claim 7, further comprising:
storing at least one of updated first service data flow group or updated second service data flow group into at least one of:
a local storage;
a unified data repository (UDR);
a unified data management function (UDM); or
an unstructured data storage function (UDSF).

9. The method of claim 1, further comprising:
in response to the request message indicating to remove the service data flow from the second service data flow group, retaining or releasing an AF session corresponding to the request message.

10. The method of claim 1, wherein receiving the request message sent by the AF comprises:
receiving the request message sent by the AF through a network exposure function (NEF); or
receiving the request message sent by the AF through a time sensitive communication and time synchronization function (TSCTSF); or
receiving the request message sent by the AF through the NEF and the TSCTSF;
or,
wherein receiving the request message sent by the AF comprises:
receiving an AF session create request or an AF session update request sent by the AF,
wherein the AF session create request or the AF session update request comprises the request message;
or,
wherein receiving the request message sent by the AF comprises:
receiving the request message sent by the AF in at least one procedure of:
a setting up an AF session procedure;
an AF session update procedure;
a service specific parameter provisioning procedure; or
a procedure of setting a policy for a further AF session.

11-12. (canceled)

13. A method for managing a multimodal service data flow, performed by an application function (AF), comprising:
sending a request message to a PCF, wherein the request message is configured to indicate at least one of:
adding a service data flow to a first service data flow group; or
removing a service data flow from a second service data flow group.

14. The method of claim 13, wherein the request message comprises a group identifier corresponding to the service data flow, and the group identifier is associated with the first service data flow group or the second service data flow group;
wherein the request message further comprises an action indication corresponding to the service data flow.

15. (canceled)

16. The method of claim 14, wherein in a case where the group identifier is associated with the first service data flow group, the action indication indicates at least one of:
adding the service data flow to the first service data flow group; or
removing the service data flow from the second service data flow group.

17. The method of claim 16, wherein before sending the request message to the PCF, the service data flow is located in the second service data flow group, or does not belong to any service data flow group.

18. The method of claim 14, wherein in a case where the group identifier is associated with the second service data flow group, the action indication indicates to remove the service data flow from the second service data flow group.

19. The method of claim 13, further comprising:
in response to the request message indicating to remove the service data flow from the second service data flow group, retaining or releasing an AF session corresponding to the request message.

20. The method of claim 13, wherein sending the request message to the PCF comprises:
sending the request message to the PCF through a NEF; or
sending the request message sent to the PCF through a TSCTSF; or sending the request message sent to the PCF through the NEF and the TSCTSF;
or,
wherein sending the request message to the PCF comprises:
sending an AF session create request or an AF session update request to the PCF, wherein the AF session create request or the AF session update request comprises the request message;
or,
wherein sending the request message to the PCF comprises:
sending the request message to the PCF in at least one procedure of:
a setting up an AF session procedure;
an AF session update procedure;
a service specific parameter provisioning procedure; or
a procedure of setting a policy for a further AF session.

21-24. (canceled)

25. A policy control function (PCF), comprising a processor and a memory, wherein the memory is stored with a computer program, and the processor is configured to execute the computer program stored in the memory, to:
receive a request message sent by an application function (AF), wherein the request message is configured to indicate at least one of:
adding a service data flow to a first service data flow group; or
removing a service data flow from a second service data flow group; and
generate or update a policy and charging control (PCC) rule according to the request message.

26. An application function (AF), comprising a processor and a memory, wherein the memory is stored with a computer program, and the processor is configured to execute the computer program stored in the memory, to implement the method of claim 13.
